(19) United States
(12) Patent Application Publication
(10) Pub. No.: US 2007/0132786 A1
(43) Pub. Date: Jun. 14, 2007

(54) Segment-based video and graphics system with video window

(75) Inventors: Chin-Chung Yen, Taipei City (TW); Howard Cheng, Taipei City (TW); Je-Hsin Lee, Taipei City (TW)

Correspondence Address: CHARLES E. BAXLEY, ESQ., 90 JOHN STREET, THIRD FLOOR, NEW YORK, NY, 10038, US

(73) Assignee: Prolific Technology INC.

(21) Appl. No.: 11/294,771

(22) Filed: Dec. 5, 2005

(51) Int. Cl. G09G 5/00

(52) U.S. Cl. 345/660

(57) ABSTRACT

The present invention provides a system for a video window in a graphics background of a screen. The video window is allowed to be removed anywhere and be scaled up or down. The system comprises a receiving module to receive the video and graphics data and group both of the data in segment, a scaling module to process the scaling by applying the provided recursive pixel-extracting algorithm for the video segment, and an overlapping module to post the scaled video data on the graphics data in accordance with a boundary condition.

### BACKGROUND OF THE PRESENT INVENTION

1. Field of Invention

The present invention relates to a video and graphics system, more particularly to a segment-based video and graphics system with video window.

2. Description of Related Arts

The conventional way to deal with a frame including graphics and video data, such as a video window in a graphics background, needs a big buffer for storing the data of a line of a frame and a mass calculation (or overlapping the video data on graphic data. The video window cannot be moved and scaled up or down. It has limited the development of the portable displaying products because of consideration of the cost and performance of the CPU and memory. Therefore, there is a need to propose an improved video and graphics system to overcome the problems as mentioned above.

### SUMMARY OF THE PRESENT INVENTION

A main object of the present invention is to provide a video and graphics system for displaying video/graphics mixed content without the need of mass memory. To achieve the objective, the present invention employs a segment-based process without need to build a mass memory for the data of a whole line of the video window.

Another object of the present invention is to provide a video and graphics system to allow the user to remove the video window anywhere on the screen. To achieve the objective, the present invention provides a mechanism to detect the boundary of the video data and graphics data.

Another object of the present invention is to provide a video and graphics system to allow the user to scale up or down the video window. To achieve the objective, the present invention provides a new algorithm to process a segment at a time instead of a line like the conventional way.

In accordance with the invention, the video and graphics system comprises a receiving module for receiving the data and group the data in segment, a scaling module to process the scaling by employing the provided recursive pixel-extracting algorithm, and an overlapping module to post the video data on the graphics data.

One or part or all of these and other features and advantages of the present invention will become readily apparent to those skilled in this art from the following description wherein there is shown and described a preferred embodiment of this invention, simply by way or illustration of one of the modes best suited to carry out the invention. As it will be realized, the invention is capable of different embodiments, and its several details are capable of modifications in various, obvious aspects all without departing from the invention. Accordingly, the drawings and descriptions will be regarded as illustrative in nature and not as restrictive.

### BRIEF DESCRIPTION OF THE DRAWINGS

FIG. 1 illustrates a preferred embodiment in accordance with the present invention.

FIGS. 2A and 2B illustrate the algorithm employed in the scaling module for scaling.

FIG. 3 illustrates the content of a segment.

FIG. 4 illustrates an example of the segment.

### DETAILED DESCRIPTION OF THE PREFERRED EMBODIMENT

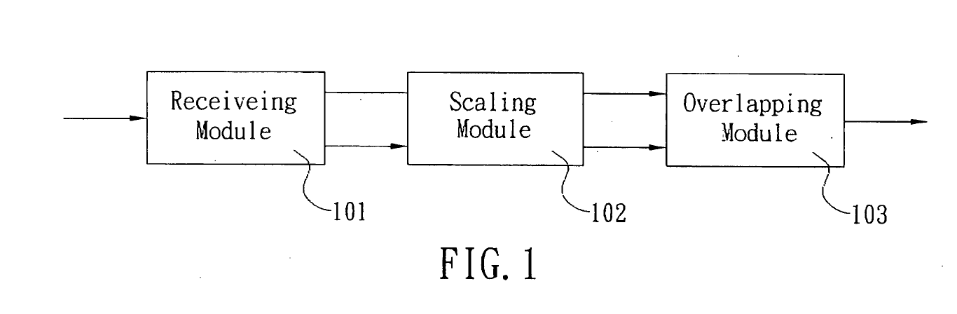

FIG. 1 is a preferred embodiment to illustrate the video and graphics system in accordance with the present invention. The receiving module 101 accepts n pixels data from a memory device each time. The n pixels data may be, for example, 8 pixels data. Additionally, the n pixels data may include graphics data, or both graphics data and video data. The received data of every n pixels, but not restricted, are grouped as a segment to process.

For example, the menu picture of the DVD of a movie may include a graphics picture as the background and one or more video windows to show the motion picture, i.e. video data. In the region of the video window to show the motion picture, the video data are pasted on the graphics data at the pixels. That is to say, the pixels within the video window include both graphics data and video data.

The video window could cover a portion of the segment. The covered portion of the segment includes video data and the uncovered portion of the segment includes graphics data. For example, the first 3 pixels of 8 pixels data of the segment are graphics data and the last 5 pixels of 8 pixels data of the segment are video data if the segment covers the beginning portion of the video window. Or the first 2 pixels of 8 pixels data of the segment are video data and the last 6 pixels of 8 pixels data of the segment are graphics data if the segment covers the end portion of the video window.

The video and graphics system identifies differences between typical video and graphics data to detect the edges of video windows. By detecting the edges of video windows within a graphics image, the video and graphics system may uniquely adjust image characteristics of an exposed video window. These characteristics include, for example, hue, brightness, intensity and contrast.

To detect the edges of video windows, the segments are duplicated twice. One comprises the graphics data only, and another comprises the video data only. The segments of the boundary cases comprise the boundary information to indicate which pixel the video window starts from or ends at. It allows the viewer to move the video window anywhere on the screen. The boundary information may be recorded in the corresponding entries of the relevant pixels. For the other cases, the segments comprise the graphics data only or video data only.

There is a storage device (not shown) in the graphic/video data in module 101 to store one or more segments after receiving the data from a memory device. Multiple segments may be employed for pipelined processing.

Next, the video data is transferred to the video-scaling module 102. The video scaling module 102 processes a segment at a time and employs the recursive pixel extract algorithm to scale up or down the motion picture. The algorithm calculates the necessary parameters to select the pixels needed to be reserved and the scaling factor, and then produces the interpolated pixels in accordance with the scaling factor to achieve the scaling.

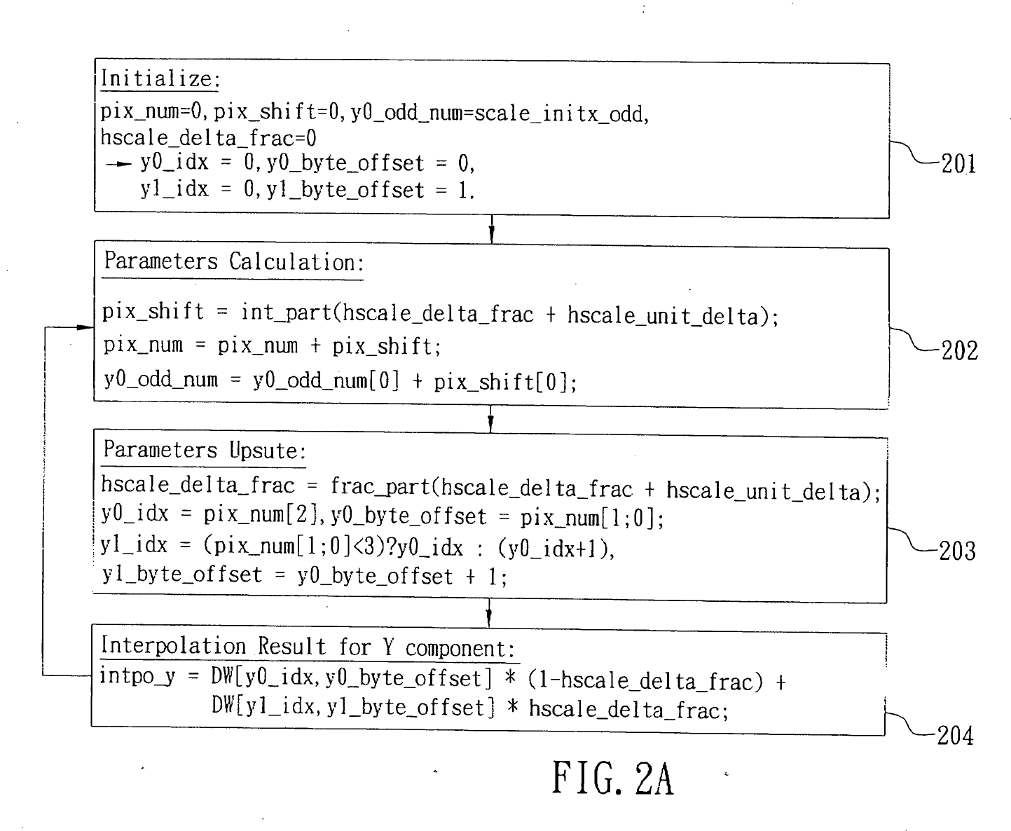

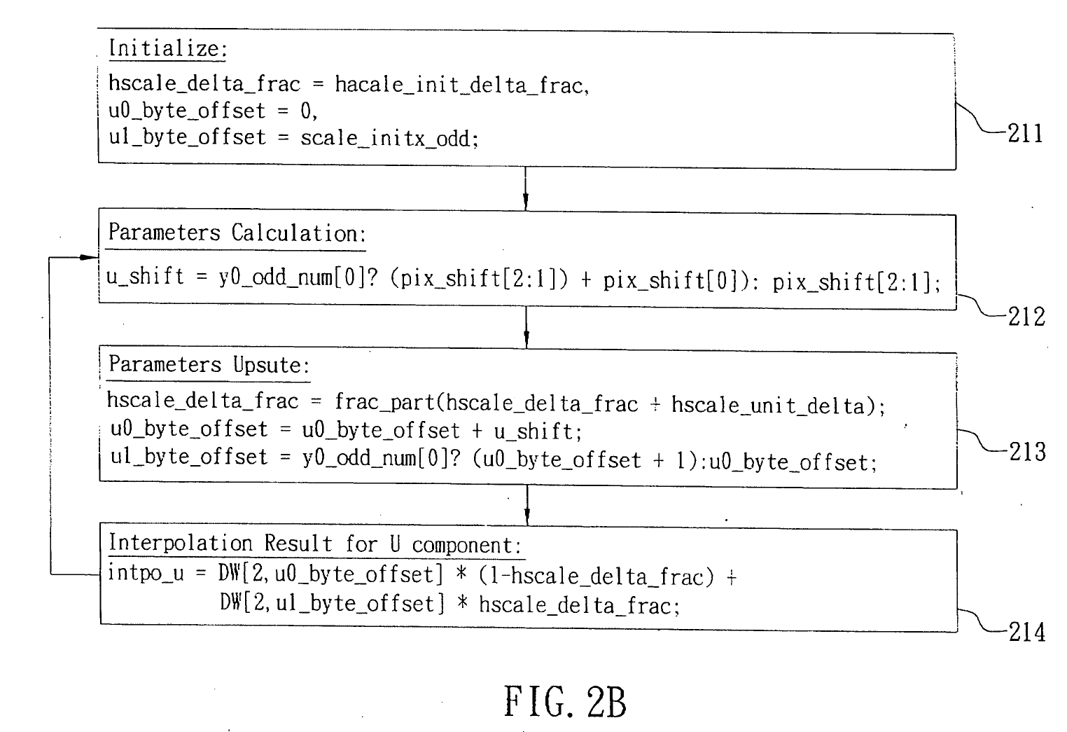

Referring to FIGS. 2A and 2B, the recursive pixel extract algorithm is illustrated. FIG. 2A is for the extraction of the Y component, and the U and V components have the same algorithm as shown in FIG. 2B. FIG. 3 is the format of the data of a segment. The data of a pixel is in YUV420 format. The component of a pixel is determined by two indexes, the offset and component_idx.

The following is the expressions of the parameters in FIGS. 2A and 2B. The pix_num is position of the pixel in the string of the 8 pixels. The pix_shift is the shifted placement from the original pixel. The y0_odd_num=0 means the adjacent up and down pixels of the first and the second lines share the same U and V components, so as the third and forth lines, and so on. The y0_odd_num=1 means the pixels of the first line have their own U and V components, the adjacent up and down pixels of the second and third lines share the same U and V components, so as the forth and fifth lines, and so on. The hscale_delta_frac is the fraction of the interpolation. The hscale_unit_delta is the scaling factor, the original size divided by the scaled size, The int_part means the integer part of the relevant parameters. The frac_part means the fraction part of the relevant number. The [number] means the bit number. For example, bus[0] means bit_0 of the Bus. The y0 and y1 are the Y components of the pixels for the interpolation, that is the extracted y is the summation of the fractional y0 and fractional y1, and so as the u0, u1, and v0, v1.

Now referring to FIGS. 2A and 2B, the steps 201 and 211 initialize the necessary parameters of the algorithm. The steps 202 and 212 calculate the shifting to select the reference pixels for the extraction in accordance with the scaling rate. The steps 203 and 213 update the necessary parameters for interpolation and the next extraction. The steps 204 and 214 determine the interpolation result added between the reference pixels. The steps 202-204 and the steps 212-214 are repeated until the whole segment is processed.

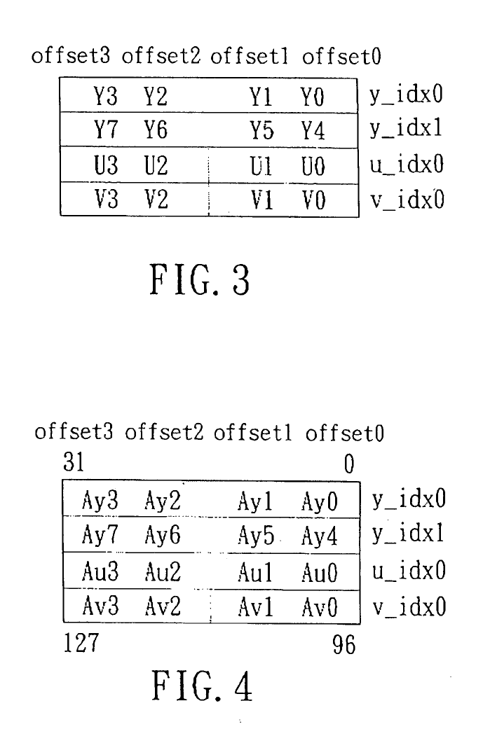

The following is the example to illustrate how the algorithm works. The original video window is scaled up from 240 pixels (A0, A1,? A239) to 320 pixels (B0, B1, ? B319) in width. Every pixel comprises (Y, U, V), so A0=(Ay0, Au0, Av0), and B0=(By0, Bu0, Bv0), and so on. The segment, DW, including the data of the first 8 pixels from A0 to A7 is shown in FIG. 4. The Ay0 is determined by the DW[offset0, y_idx0] that is DW[0, 0], and the Ay4 is determined by the DW[offset0, y_idx1] that is DW[0, 1], and so on.

The hscale_unit_delta=240/32−0.75, and assume the scale_init_odd=0.

Step 1: initialization
pix num=0, pix_shift=0, y0_odd_num=0, hscale−delta−frac−0,
y0_idx=0, y1_idx=0,
y0_byte_offset=0, y1_byte_offset=0,
u0_byte_offset=0, u1_byte_offset=0,
v0_byte_offset=0, v1_byte_offset=0,
By0=Ay0*(1−0)+Ay1*0=Ay0,
Bu0=Au0,
Bv0=Av0;

Step 2a: parameters calculation
pix_shift=int_part (0+0.75)=0,
u_shift=pix_shift[2:1]=0,
v_shift=pix_shift[2:1]=0,
pix_num=0+0=0,
y0_odd_num=0+0=0,

Step 3a: parameter update
hscale_delta_frac=frac_part(0+0.75)=0.75,
y0_idx=pix_num[2]=0, y1_idx=y0_idx=0,
y0_byte_offset=pix_num[1:0]=0, y1_byte_offset=0+1=1,
u0_byte_offset=0+0=0, u1_byte_offset=0,
v0_byte_offset=0+0=0, v1_byte_offset=0,

Step 4a: interpolation result
By1=Ay0*(1−0.75)+Ay1*0.75=Ay0*0.25+Ay1*0.75,
Bu1=Au0*(1−0)+Au0*0=Au0,
Bv1=Av0*(1−0)+Av0*0=Av0;

Step 2b: parameters calculation
pix_shift=int_part (0.75+0.75)=0,
u_shift−pix_shift[2:1]=0,
v_shift=pix_shift[2:1]=0,
pix_num=0−1=1,
y0_odd_num=0+1=1,

Step 3b: parameter update
hscale_delta_frac=frac_part(0.75+0.75)=0.5,
y0_idx=pix_num[2]=0, y1_idx=y0_idx=0,
y0_byte_offset=pix_num[1:0]−1, y1_byte_offset=1+1=2,
u0_byte_offset=0+0=0, u1_byte_offset=0+1=1,
v0_byte_offset=0+0=0, v1_byte_offset=0+1=1,

Step 4b: interpolation result
By2=Ay0*(1−0.5)+Ay1*0.5=Ay1*0.5+Ay2*0.5,
Bu2=Au0*(1−0.5)+Au1*0.5=Au0*0.5+Au1*0.5,
Bv2=Av0*(1−0.5)+Av1*0.5=Av0*0.5+Av1*0.5,

Step 2c: parameters calculation
pix_shift=int_part(0.5+0.75)=1,
u_shift=pix_shift[2:1]=1,
v_shift=pix_shift[2:1]=1,
pix_num=1−1=2,
y0_odd_num=1+1=2;

Step 3c: parameter update
hscale_delta_frac=frac_part(0.5+0.75)=0.25,
y0_idx=pix_num[2]=0, y1_idx=y0_idx=0,
y0_byte_offset=pix_num[1:0]=2, y1_byte_offset=2+1 =3,
u0_byte_offset=0+0=0, u1_byte_offset=u0_byte_offset=1,
v0_byte_offset=0+0=0, v1_byte_offset=v0_byte_offset=1,

Step 4c: interpolation result
By3=Ay2*(1−0.25)+Ay3*0.25=Ay2*0.75+Ay3*0.25,
Bu3=Au1*(1−0.25)+Au1*0.25=Au1,
Bu3=Av1*(1−0.25)+Av1*0.25=Av1,

By repeating the algorithm, the scaled video window is achieved.

At last, the scaled video data is transmitted to the overlapping module 103 to overlap the corresponding graphics data coming from the receiving module 101 in accordance with the boundary information in the boundary cases, and then output to display on a screen. It the received data of the system is to show a motion picture, there is no need to do the overlapping. If the received data is graphics only, there is no need to do the scaling and overlapping. By employing the present invention, a motion picture window posted upon a graphics background on a screen can he moved anywhere on the screen and can be scaled up or down.

Although the invention has been described and illustrated with reference to specific illustrative embodiments thereof, it is not intended that the invention be limited to those illustrative embodiments. Those skilled in the art will recognize that variations and modifications can be made without departing from the spirit of the invention. It is therefore intended to include within the invention all such variations and modifications which fall within the scope of the appended claims and equivalents thereof.

One skilled in the art will understand that the embodiment of the present invention as shown in the drawings and described above is exemplary only and not intended to be limiting.

The foregoing description of the preferred embodiment of the present invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A method of scaling a video window to display video data on a screen, comprising the steps of:
providing said video window having a plurality of lines, each of said lines comprising a plurality of pixels;
dividing said pixels into a plurality of pixel sets, each of said pixels comprises a data in a component type;
determining a scaling factor for said video window;
determining a first pixel and a second pixel in accordance with said scaling factor;
determining an extracted data in said component type of an extracted pixel in accordance with said first pixel and said second pixel and said scaling factor; and
outputting said extracted data in said component type of said extracted pixel.

2. The method of scaling a video window to display video data on a screen according to claim 1, wherein said component type comprises a Y component, a U component, or a V component.

3. The method of scaling a video window to display video data on a screen according to claim 1, wherein said scaling factor comprises a first pixel number of said video window before scaling divided by a second pixels number of said video window after scaling.

4. The method of scaling a video window to display video data on a screen according to claim 1, wherein said extracted pixel locates between said first and said second pixels.

5. The method of scaling a video window to display video data on a screen according to claim 1, wherein said scaling factor determines a first weighting factor for said first pixel and a second weighting factor for said second pixel.

6. The method of scaling a video window to display video data on a screen according to claim 1, wherein said extracted pixel is an interpolation result of said fist pixel, said first weighting factor, said second pixel and said second weighting factor.

7. A video and graphics system for scaling a video window to display video data on a screen, comprising:
a receiving module for receiving a plurality of pixel data of a plurality of corresponding continuous pixels, and dividing said pixel data into a plurality of pixel data sets, wherein each of said pixel data sets comprises a video data set and a graphics data set;
a scaling module for receiving a target video data set of target pixel data set from said pixel data sets and scaling said target video data set in accordance with a scaling factor; and
an overlapping module for receiving said scaled target video data set from said scaling module and a target graphics data set of said target pixel data set from said receiving module, and overlapping said scaled target video data onto said target graphics data set in accordance with a boundary information.

8. The video and graphics system for scaling a video window to display video data on a screen according to claim 7, wherein said boundary information indicates where said video data start or end in a corresponding data set.

9. The video and graphics system for scaling a video window to display video data on a screen according to claim 7, wherein said scaling factor is determined by a first pixel number of said video window before scaling divided by a second pixels number of said video window after scaling.
